(19) United States
(12) Patent Application Publication
(10) Pub. No.: US 2024/0330994 A1
(43) Pub. Date: Oct. 3, 2024

(54) INFORMATION PROCESSING APPARATUS AND PRODUCT INFORMATION NOTIFICATION SYSTEM

(71) Applicant: Toshiba Tec Kabushiki Kaisha, Tokyo (JP)

(72) Inventor: Koudai YAMASHITA, Izunokuni Shizuoka (JP)

(21) Appl. No.: 18/582,268

(22) Filed: Feb. 20, 2024

(30) Foreign Application Priority Data
Apr. 3, 2023 (JP) 2023-060115

(51) Int. Cl. G06Q 30/0283

(52) U.S. Cl. CPC G06Q 30/0283

(57) ABSTRACT

According to an embodiment, an information processing apparatus moves around a sales floor with a customer and executes processing relating to product registration. The information processing apparatus inputs specific information for specifying a product sold in the sales floor and a price of the product. The information processing apparatus displays information of a registered product on the basis of the input specific information. Further, the information processing apparatus acquires information regarding a discounted product sold in the sales floor and displays the acquired information regarding a discounted product.

### CROSS-REFERENCE TO RELATED APPLICATIONS

This application is based upon and claims the benefit of priority from the prior Japanese Patent Application No. 2023-60115, filed on Apr. 3, 2023, the entire contents of which are incorporated herein by reference.

### FIELD

An embodiment to be described here generally relates to an information processing apparatus and a product information notification system.

### BACKGROUND

In stores such as supermarkets, food products with close expiration dates, products with special sale periods, and the like are sold at prices lower than normal prices (list prices or unit prices initially set by the store). In the following description, a product sold at a price lower than the normal price will be referred to also as a “discounted product”.

In the past, an advertising management system that notifies a customer of the discounted product set by a store has been proposed. This advertising management system notifies a signage in a sales floor or a mobile terminal of the customer of the remaining number of discounted products sold in the sales floor in order to inform the customer of the discounted products.

Further, in recent years, stores have adopted a self-service (Point Of Sales) system (POS) that moves around a sales floor. This self-service POS system that moves around a sales floor performs an operation relating to registration of product information of a product to be purchased by a customer himself/herself in the sales floor (hereinafter, referred to also as “product registration”) using a registration terminal that moves in the sales floor with the customer, such as a smartphone and a tablet terminal.

In such a self-service POS system that moves around a sales floor, the customer pays close attention to products and the registration terminal in the sales floor. For this reason, in the case of notifying a signage in a sales floor or a mobile terminal of a customer of information regarding a discounted product (hereinafter, referred to also as “discount information”) as in the existing advertising management system, the customer often does not notice the notified discount information and is difficult to recognize the discount information.

### BRIEF DESCRIPTION OF THE DRAWINGS

FIG. 1 is a schematic diagram showing a product information notification system according to a first embodiment.

FIG. 2 is a block diagram showing a main hardware configuration of a server apparatus according to the first embodiment.

FIG. 3 is a diagram showing a data configuration of a product master stored in a storage device of the server apparatus according to the first embodiment.

FIG. 4 is a diagram showing a data configuration of an inventory management table stored in the storage device of the server apparatus according to the first embodiment.

FIG. 5 is a diagram showing a data configuration of a customer information management table stored in the storage device of the server apparatus according to the first embodiment.

FIG. 6 is a diagram showing a data configuration of a transaction information management table stored in the storage device of the server apparatus according to the first embodiment.

FIG. 7 is a block diagram showing a main functional configuration of a controller of the server apparatus according to the first embodiment.

FIG. 8 is a block diagram showing a main hardware configuration of a registration terminal according to the first embodiment.

FIG. 9 is a block diagram showing a main functional configuration of a controller of the registration terminal according to the first embodiment.

FIG. 10 is a sequence chart showing an operation of the product information notification system according to the first embodiment.

FIG. 11 is a diagram showing a start screen displayed on a display device of the registration terminal according to the first embodiment.

FIG. 12 is a diagram showing a discount information list screen displayed on the display device of the registration terminal according to the first embodiment.

FIG. 13 is a diagram showing a map screen displayed on the display device of the registration terminal according to the first embodiment.

FIG. 14 is a flowchart showing discount information display processing performed by the controller of the registration terminal according to the first embodiment.

FIG. 15 is a diagram showing a data configuration of a map display setting table stored in a storage device of a server apparatus according to a second embodiment.

FIG. 16 is a sequence chart showing an operation of a product information notification system according to the second embodiment.

FIG. 17 is a diagram showing a registration screen displayed on a display device of a registration terminal according to the second embodiment.

FIG. 18 is a flowchart showing registration processing performed by a controller of the registration terminal according to the second embodiment.

FIG. 19 is a diagram showing a data configuration of a product master stored in a storage device of a server apparatus according to a modification.

FIG. 20 is a diagram showing a data configuration of a discount information management table stored in a storage device of the server apparatus according to the modification.

### DETAILED DESCRIPTION

According to an embodiment, an information processing apparatus moves around a sales floor with a customer and executes processing relating to product registration. The information processing apparatus includes: an input device; a communication device; a display device; and a controller. The input device inputs specific information for specifying a product sold in the sales floor and a price of the product. The communication device communicates with a server apparatus. The server apparatus manages discount information of a product sold in the sales floor and outputs information regarding a discounted product. Further, the server apparatus registers a product on the basis of the specific information input by the input device. The display device displays information regarding the product registered by the server apparatus. The controller is configured to acquire the information regarding a discounted product from the server via the communication device. The controller is further configured to display the acquired information regarding a discounted product on the display device.

An information processing apparatus and a product information notification system according to embodiments will be described below with reference to the drawings. The same reference symbols in the drawings will denote the same or similar portions. Note that the embodiments are not limited by the following description. For example, although a store lends a registration terminal that is an information processing apparatus to a customer in the embodiments described below, the present technology is not limited thereto. The registration terminal only needs to be one that moves around a sales floor with a customer and executes processing relating to product registration, and may be, for example, a smartphone of a customer in which a shopping application program is installed.

### First Embodiment

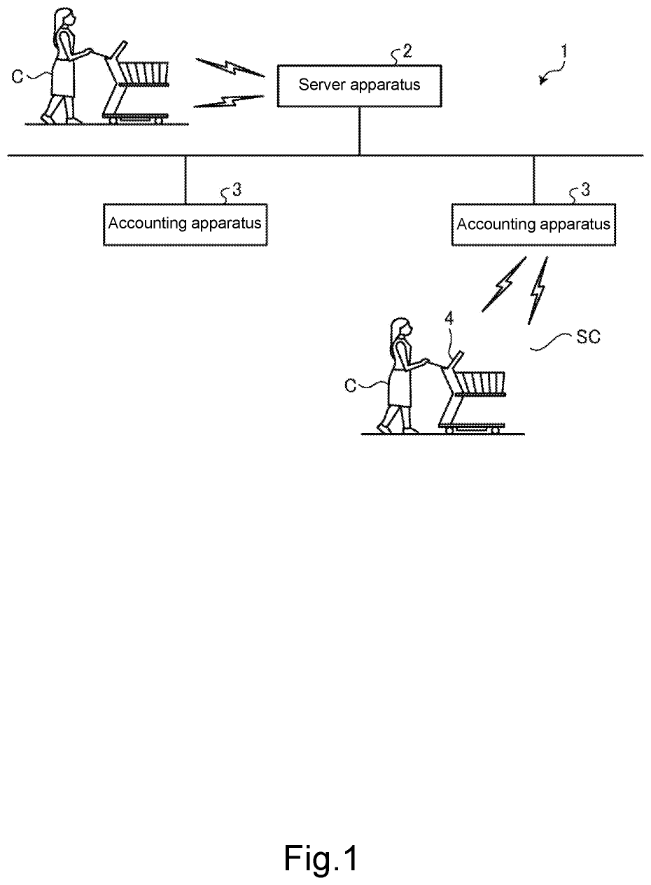

FIG. 1 is a schematic diagram showing a product information notification system 1 according to a first embodiment. The product information notification system 1 according to this embodiment is adopted by stores such as supermarkets and is applied to a self-service POS system that moves around a sales floor. The product information notification system 1 includes a server apparatus 2 managed by a store, an accounting apparatus 3, and a registration terminal 4 installed in a shopping cart SC.

The server apparatus 2, the accounting apparatus 3, and the registration terminal 4 are communicably connected to each other via a network such as a wired or wireless local area network (LAN). Note that the numbers of the server apparatus 2, the accounting apparatus 3, the registration terminal 4 are not limited to the illustrated examples. The registration terminal 4 is an example of an information processing apparatus.

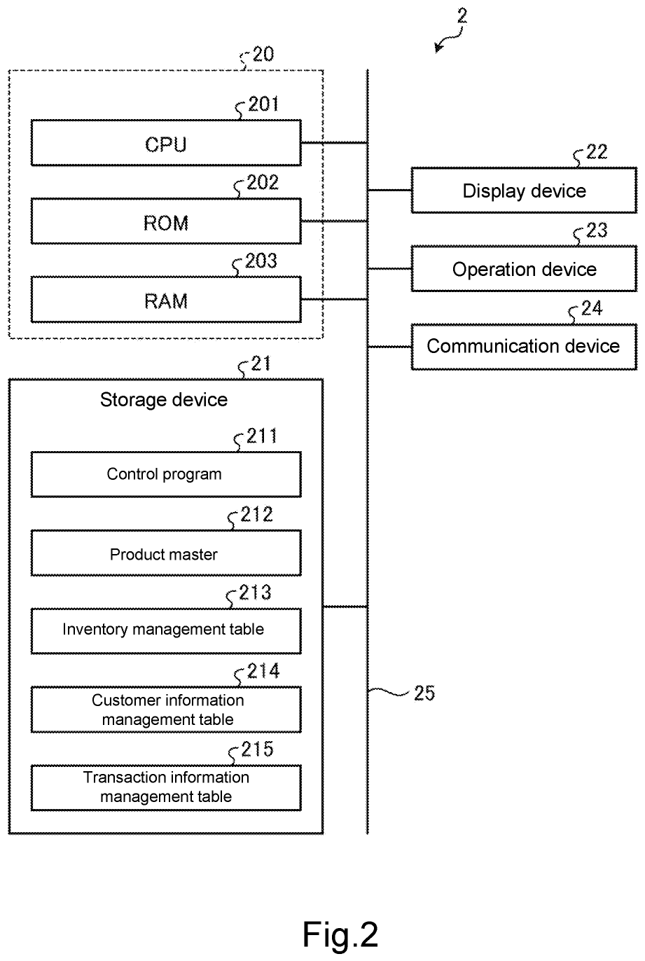

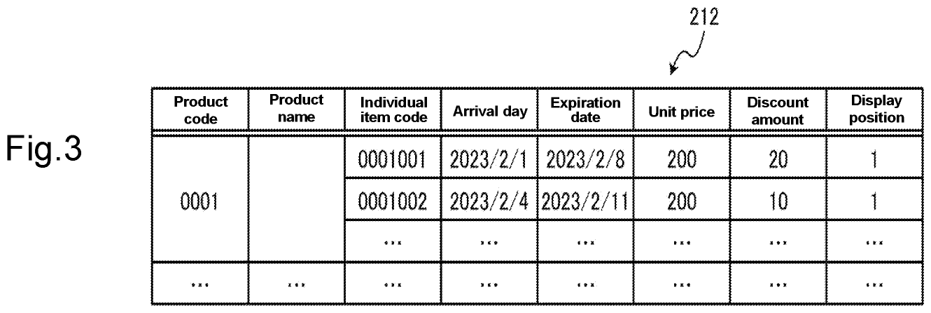

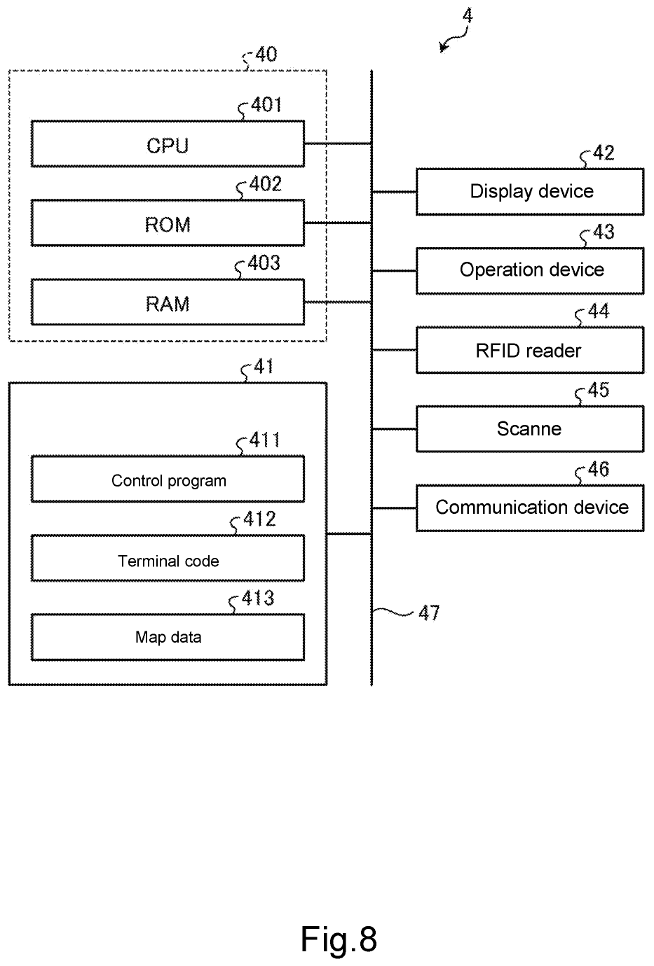

A customer C shops while moving the shopping cart SC in which the registration terminal 4 is installed, in a sales floor. The customer C registers, in the sales floor, information regarding a product to be purchased in the server apparatus 2 using the registration terminal 4 of the shopping cart SC. For example, the registration terminal 4 receives an operation of the customer C to read, by a radio frequency identification (RFID) reader 44 (see FIG. 8), an individual item code from an RF tag attached to the product to be purchased and transmit the read individual item code to the server apparatus 2. The individual item code is information for specifying an individual item, i.e., one product. The server apparatus 2 reads product information corresponding to the received individual item code from a product master 212 (see FIG. 2 and FIG. 3) stored in the server apparatus 2 itself.

The server apparatus 2 registered the read product information. At this time, the server apparatus 2 issues a transaction code and registers the read product information as transaction information in association with the transaction code. In this way, the server apparatus 2 manages transaction information for each transaction code.

Note that the product information may be registered in the registration terminal 4. In other words, the product registration may be executed by the registration terminal 4. In this case, the registration terminal 4 may read product information corresponding to an individual item code from the product master stored in the registration terminal 4 itself or may acquire the product information from the server apparatus 2. Further, the server apparatus 2 may acquire the product code corresponding to the individual item code read by the registration terminal 4 from the registration terminal 4 to perform product registration. The product code is information for specifying a product, and is, for example, a Japanese article number (JAN) code. Further, the server apparatus 2 may acquire the product code read by the registration terminal 4 to perform product registration, as shown in the modification described below.

When the customer C completes product registration for all products to be purchased, he/she moves to the accounting apparatus 3 and inputs transaction codes to the accounting apparatus 3. The input of a transaction code is performed by, for example, reading a code symbol displayed on the registration terminal 4 by a scanner (not shown) included in the accounting apparatus 3. The accounting apparatus 3 acquires transaction information corresponding to the input transaction code from the server apparatus 2 and executes account processing for the customer C to make a payment. In this way, the customer C can complete the payment of the products to be purchased.

The registration terminal 4 is capable of displaying discount information. For example, the registration terminal 4 transmits a request for discount information to the server apparatus 2 on the basis of an operation of the customer C. The request for discount information is a request for information regarding a discounted product. The registration terminal 4 acquires discount information from the server apparatus 2 and displays the acquired discount information. As a result, the customer C can recognize, by the registration terminal 4 to which he/she pays attention during shopping, information regarding a discounted product sold in a store.

Note that the server apparatus 2 may actively transmit discount information instead of passively transmitting discount information in response to a request for discount information from the registration terminal 4. For example, the server apparatus 2 may transmit discount information to each registration terminal 4 every predetermined time.

Next, each apparatus will be described. The server apparatus 2 will be described first. FIG. 2 is a block diagram showing a main hardware configuration of the server apparatus 2. The server apparatus 2 includes a controller 20, a storage device 21, a display device 22, an operation device 23, and a communication device 24. The controller 20, the storage device 21, the display device 22, the operation device 23, and the communication device 24 are connected to each other via a bus 25 or the like. Note that the server apparatus 2 may include a plurality of computers.

The controller 20 includes a processor and a memory. The processor is, for example, a central processing unit (CPU) 201. The memory includes a read only memory (ROM) 202 and a random access memory (RAM) 203. The controller 20 includes a computer including the CPU 201, the ROM 202, and the RAM 203. The CPU 201, the ROM 202, and the RAM 203 are connected to each other via the bus 25.

The CPU 201 controls the operation of the entire server apparatus 2. The ROM 202 stores various programs such as a program to be used for driving the CPU 201 and various types of data. The RAM 203 is used as a work area of the CPU 201, and various programs and various types of data stored in the ROM 202 and the storage device 21 are developed thereinto. The controller 20 executes, when the CPU 201 operates in accordance with the control program that is stored in the ROM 202 and the storage device 21 and developed into the RAM 203, various types of control processing of the server apparatus 2.

The storage device 21 includes a storage medium such as a hard disk drive (HDD) and a flash memory, and retains the stored content even if power is cut off. The storage device 21 stores a control program 211, the product master 212, an inventory management table 213, a customer information management table 214, and a transaction information management table 215.

The control program 211 is a program for realizing, for example, a function of registering product information on the basis of the individual item code acquired from the registration terminal 4, a function of extracting discount information from the product master 212 in response to a request for discount information from the registration terminal 4, a function of transmitting the extracted discount information to the registration terminal 4, and the like.

The product master 212 is a master file in which pieces of product information regarding products available in a store are stored. Since the product available in the store changes daily, the product master 212 is appropriately updated by the store. FIG. 3 is a diagram showing a data configuration of the product master 212. The product master 212 stores a product name, an individual item code, an arrival day, an expiration date, a unit price, a discount amount, and a display position in association with a product code.

The product code is information for specifying a product. The product name is information indicating the name of the product. The individual item code is information for specifying one individual item of the product. The arrival day is information indicating the date the individual item of the corresponding individual item code arrived at the store. The expiration date is information indicating the expiration date of the product. The expiration date is registered in the case where the product is food and drink, and is an example of deadline information indicating a deadline.

The unit price is information indicating the list price of the product or the unit price initially set by the store. The discount amount is information indicating the amount of money to be discounted from the unit price. For the products other than the discounted product, “0” is registered in the discount amount. The unit price and the discount amount are examples of price information indicating a price. Note that for example, in the case where the server apparatus 2 automatically calculates the discount amount from the expiration date and the current date and time, the product master 212 does not need to store a discount amount.

The display position is information indicating the display position of the product in the sales floor and is, for example, a display shelf No. The display position is an example of position information indicating a display position. The individual item code is information having a function of specifying a product and a price of the product (including a discount amount), and is an example of specific information.

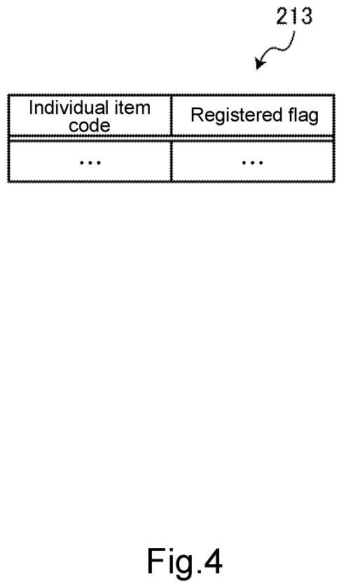

The inventory management table 213 is a data table for managing the inventory of products. FIG. 4 is a diagram showing a data configuration of the inventory management table 213. The inventory management table 213 stores the individual item code and a registered flag in association with each other.

The individual item code: is information for specifying one individual item of the product as described above. The registered flag is information indicating whether or not product registration has been performed on the individual item of the corresponding individual item code. “0” is registered in the case where the product registration has not been made, and “1” is registered in the case where product registration is made. Note that the registered flag may be rewritten to “1” on the condition that account processing was performed on the individual item of the corresponding individual item code by the accounting apparatus 3. In other words, the registered flag may be information indicating whether or not the individual item was sold.

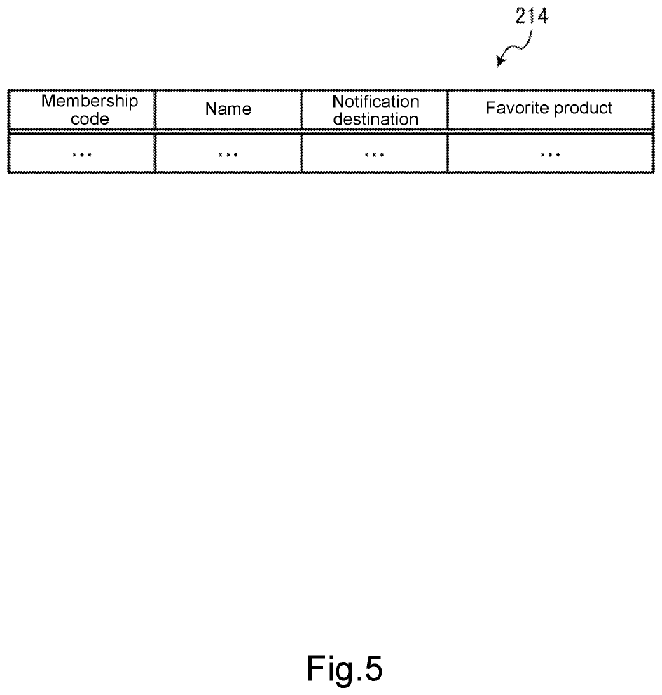

The customer information management table 214 is a data table for managing information regarding the customer C who is a store member. The information to be registered in the customer information management table 214 is acquired from the customer C when performing membership registration of the store member, for example. FIG. 5 is a diagram showing a data configuration of the customer information management table 214. The customer information management table 214 stores a name, a notification destination, and a favorite product in association with a membership code.

The membership code is information for specifying a store member and is, for example, a member No. The name is information indicating the name of the store member. The notification destination is information indicating the notification destination of the store member and is, for example, an e-mail address. The favorite product is information indicating the favorite product specified by the customer C and is the product code or the like of the favorite product. Note that the favorite product may be registered on the basis of the past purchase history of the customer C.

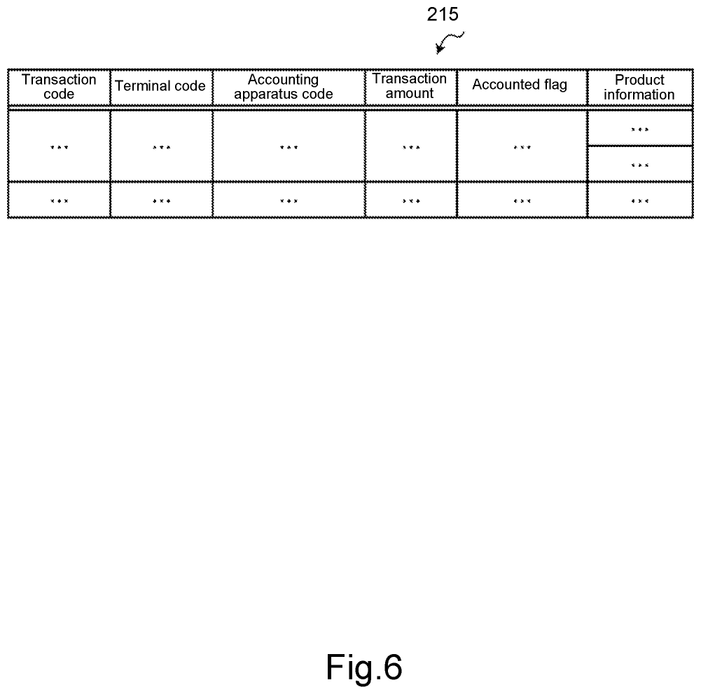

The transaction information management table 215 is a data table for managing transaction information of the customer C for each transaction. The transaction information is information to be used when the accounting apparatus 3 executes account processing. The transaction information management table 215 is appropriately updated on the basis of information from the registration terminal 4 and the accounting apparatus 3. FIG. 6 is a diagram showing a data configuration of the transaction information management table 215. The transaction information management table 215 stores a terminal code, an accounting apparatus code, a transaction amount, an accounted flag, and product information in association with a transaction code.

The transaction code is information for specifying the transaction and is issued by the controller 20. The terminal code is information for specifying the registration terminal 4. The accounting apparatus code is information for specifying the accounting apparatus 3. The transaction amount is information indicating the total amount of one transaction. The accounted flag is information indicating whether or not the customer C completed the payment of the transaction amount. In the accounted flag, “0” is registered in the case where the accounting apparatus 3 has not completed the account processing relating to the transaction specified by the transaction code, and “1” is registered when the accounting apparatus 3 completes the account processing.

The product information is information regarding a product that is a target of a transaction and includes, for example, a product code, a product name, a unit price, and a discount amount. Since these pieces of product information have been described in the description of the product master 212, overlapping description will be omitted. In the case where a plurality of products is purchased in one transaction, a plurality of pieces of product information is registered corresponding to one transaction code.

With reference to FIG. 2 again, a hardware configuration of the server apparatus 2 will be described.

The display device 22 includes, for example, a liquid crystal panel, and displays various types of information. The display device 22 displays, for example, information stored in the product master 212, the inventory management table 213, the customer information management table 214, the transaction information management table 215, and the like, as necessary.

The operation device 23 is for inputting information to the controller 20, and includes a keyboard, a touch panel, a mouse, and the like.

The communication device 24 is an interface for communicating with an external device such as the accounting apparatus 3 and the registration terminal 4. The controller 20 is capable of transmitting/receiving information (data) to/from an external device by being connected to the external device via the communication device 24.

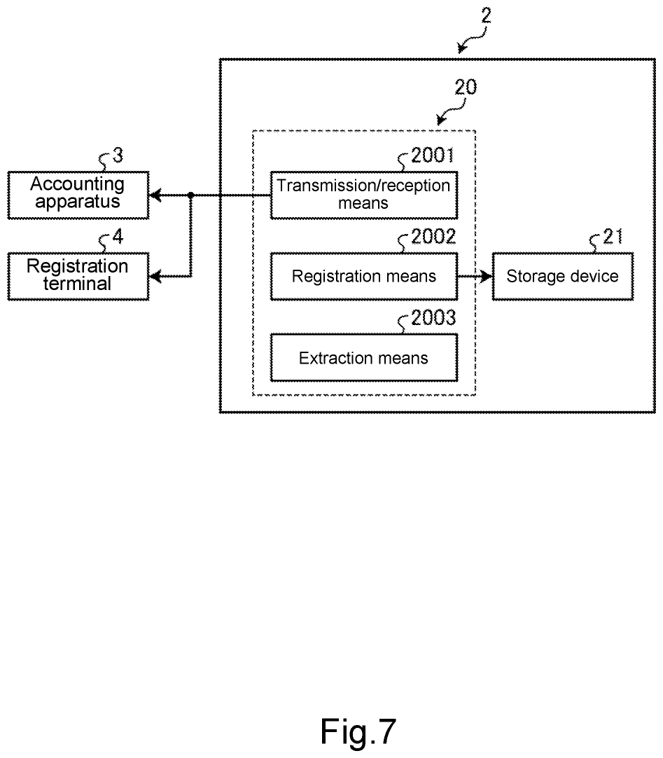

Subsequently, a functional configuration of the server apparatus 2 will be described. FIG. 7 is a block diagram showing a main functional configuration of the controller 20 of the server apparatus 2. The controller 20 functions as a transmission/reception means 2001, a registration means 2002, and an extraction means 2003 when the CPU 201 operates in accordance with the control program stored in the ROM 202 or the storage device 21. Note that these functions may be realized by hardware such as a dedicated circuit.

The transmission/reception means 2001 transmits/receives various types of information to/from the accounting apparatus 3 and the registration terminal 4. For example, the transmission/reception means 2001 receives a request for transaction information from the accounting apparatus 3. The request for transaction information is a request for transaction information necessary for account processing, and includes a transaction code for specifying a transaction. The transmission/reception means 2001 transmit transaction information to the accounting apparatus 3 as a response to the request for transaction information from the accounting apparatus 3. Further, the transmission/reception means 2001 receives accounting completion notification from the accounting apparatus 3. The accounting completion notification is information indicating that account processing was completed, i.e., payment relating to the transaction was completed, and includes a transaction code for specifying a transaction of which account processing was completed.

The transmission/reception means 2001 receives a request for discount information from the registration terminal 4 and transmits discount information to the registration terminal 4 as a response thereto. The transmission/reception means 2001 functions as an output means that outputs information regarding a discounted product to the registration terminal 4. Further, the transmission/reception means 2001 receives a registration request from the registration terminal 4. The registration request is a request for product registration and includes an individual item code of a product that is a target of product registration. When product registration is completed in accordance with the registration request from the registration terminal 4, the transmission/reception means 2001 transmits registration notification indicating that product registration was completed to the registration terminal 4.

The registration means 2002 executes product registration. Specifically, the registration means 2002 reads, from the product master 212, product information corresponding to the individual item code included in the registration request received by the transmission/reception means 2001, and registers necessary information in the transaction information management table 215. When the transmission/reception means 2001 receives a first registration request in one transaction, the registration means 2002 issues a transaction code and registers product information in association with the transaction code. At this time, the registration means 2002 registers “0” in the corresponding accounted flag.

The registration means 2002 stores (registers) various other types of information in the storage device 21. For example, the registration means 2002 updates the inventory management table 213 when executing product registration. Specifically, the registration means 2002 rewrites the registered flag corresponding to the individual item code received from the registration terminal 4 during product registration to “1”. Further, when the transmission/reception means 2001 receives accounting completion notification, the registration means 2002 updates the transaction information management table 215. Specifically, the registration means 2002 rewrites the accounted flag corresponding to the transaction code included in the accounting completion notification received from the accounting apparatus 3 to “1”.

When the transmission/reception means 2001 receives a request for discount information from the registration terminal 4, the extraction means 2003 extracts an individual item code of a discounted product from the product master 212. Subsequently, the extraction means 2003 extracts an individual item code for which “0” is registered in the registered flag in the inventory management table 213, of the individual item codes extracted from the product master 212. In other words, the extraction means 2003 extracts an individual item code of a discounted product on which product registration has not been performed.

Subsequently, the extraction means 2003 extracts an individual item code corresponding to a favorite product of the customer C, of the individual item codes of the discounted products on which product registration has not been performed. In detail, the extraction means 2003 reads, from the customer information management table 214, a product code corresponding to a membership code included in the request for discount information. The extraction means 2003 then extracts one whose corresponding product code matches the product code read from the customer information management table 214, of the individual item codes of the discounted products on which product registration has not been performed.

The extraction means 2003 refers to the product master 212 to generate, discount information, product information corresponding to the extracted individual item code. The discount information may be a collection of pieces of product information for each individual item code or may be a collection of pieces of product information for each group product, the group product being of the same product and the same discount amount.

Next, the accounting apparatus 3 will be described. The accounting apparatus 3 is, for example, a so-called self-service accounting apparatus that the customer C himself/herself performs an accounting operation. The accounting apparatus 3 acquires, from the server apparatus 2, transaction information corresponding to the input transaction code. The accounting apparatus 3 executes, on the basis of the transaction information acquired from the server apparatus 2, account processing relating to payment by cash payment or cashless payment such as credit payment. The account processing in this case is processing for the customer C to make payment for the products to be purchased.

Next, the registration terminal 4 will be described. The registration terminal 4 includes a tablet terminal, an RFID reader, a scanner, and the like owned by a store, and is attachably/detachably installed in the shopping cart SC. FIG. 8 is a block diagram showing a main hardware configuration of the registration terminal 4. The registration terminal 4 includes a controller 40, a storage device 41, a display device 42, an operation device 43, an RFID reader 44, a scanner 45, and a communication device 46. The controller 40, the storage device 41, the display device 42, the operation device 43, the RFID reader 44, the scanner 45, and the communication device 46 are connected to each other via a bus 47 or the like.

The controller 40 includes a processor and a memory. The processor is, for example, a CPU 401. The memory is, for example, a ROM 402 and a RAM 403. The controller 40 includes a computer including the CPU 401, the ROM 402, and the RAM 403. The CPU 401, the ROM 402, and the RAM 403 are connected to each other via the bus 47.

The CPU 401 controls the operation of the entire registration terminal 4. The ROM 402 stores various programs such as a program to be used for driving the CPU 401 and various types of data. The RAM 403 is used as a work area of the CPU 401, and various programs and various types of data stored in the ROM 402 and the storage device 41 are developed thereinto. The controller 40 executes, when the CPU 401 operates in accordance with the control program that is stored in the ROM 402 and the storage device 41 and developed into the RAM 403, various types of control processing of the registration terminal 4.

The storage device 41 includes a storage medium such as an HDD and a flash memory, and retains the stored content even if power is cut off. The storage device 41 stores a control program 411, a terminal code 412, and map data 413.

The control program 411 is a program for realizing, for example, a function of receiving an input of an individual item code from the RFID reader 44, a function of acquiring discount information from the server apparatus 2, a function of displaying, on the display device 42, information regarding a product on which product registration was performed, and discount information acquired from the server apparatus 2, and the like.

The terminal code 412 is information for specifying the registration terminal 4. The registration terminal 4 transmits, when transmitting information to the server apparatus 2, the information together with the terminal code 412. As a result, the server apparatus 2 is capable of specifying the registration terminal 4 that is the transmission source of the information.

The map data 413 is information indicating a map of a sales floor. The map data 413 is data including position information of a product display shelf.

The display device 42 includes, for example, a liquid crystal panel, and displays various types of information. For example, the display device 42 displays product information included in the registration notification received from the server apparatus 2. Further, the display device 42 displays the discount information received from the server apparatus 2.

The operation device 43 is for inputting information to the controller 40, and includes a keyboard, a touch panel, a mouse, and the like. For example, the operation device 43 inputs, to the controller 40, information for instructing the output of a request for discount information.

The RFID reader 44 reads an individual item code from an RF tag attached to a product to be purchased by the customer C. The RFID reader 44 reads an individual item code from an RF tag attached to a product located in a predetermined range from the registration terminal 4. For example, the reading range of the RFID reader 44 is a position where the customer C causes an individual item code to be read from an RF tag attached to a product (e.g., the vicinity of the top opening of the basket of the shopping cart SC). The RFID reader 44 does not read an individual item code from RF tags attached to products displayed on a product display shelf or products in the shopping cart SC of another customer C.

The scanner 45 reads a membership code from a medium indicating a membership code. Note that the scanner 45 may read a product code for specifying a product from a code symbol such as a barcode attached to a product, as shown in the modification described below.

The communication device 46 is an interface for communicating with an external device such as the server apparatus 2. The 40 controller is capable of transmitting/receiving information (data) to/from an external device by being connected to the external device via the communication device 46. The registration terminal 4 includes, as input devices for inputting various types of information, the touch panel of the display device 42, the operation device 43, the RFID reader 44, and the scanner 45 described above.

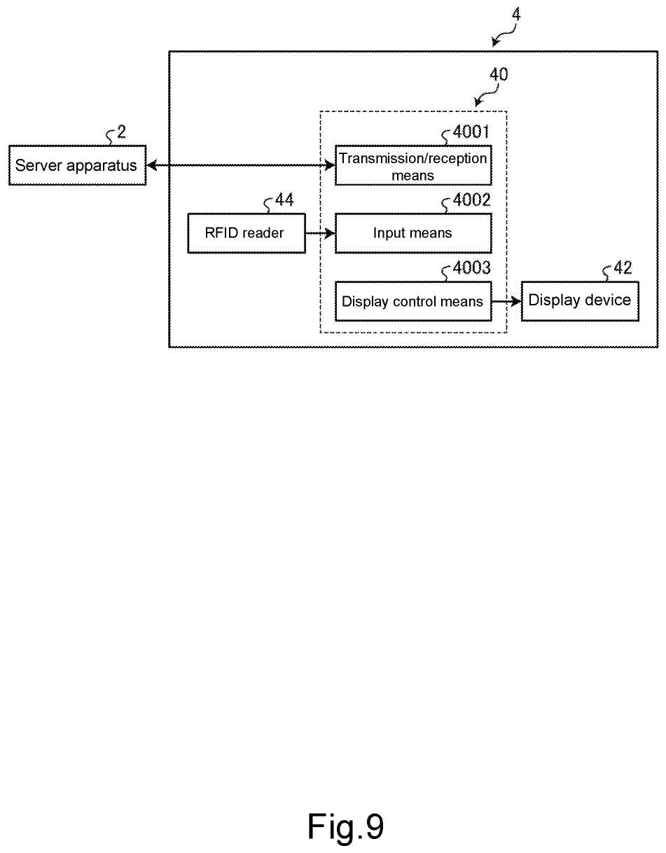

Subsequently, a functional configuration of the registration terminal 4 will be described. FIG. 9 is a block diagram showing a main functional configuration of the controller 40 of the registration terminal 4. The controller 40 functions as a transmission/reception means 4001, an input means 4002, and a display control means 4003 when the CPU 401 operates in accordance with the control program stored in the ROM 402 or the storage device 41. Note that these functions may be realized by hardware such as a dedicated circuit.

The transmission/reception means 4001 transmits/receives various types of information to/from the server apparatus 2. For example, the transmission/reception means 4001 transmits a request for discount information to the server apparatus 2, and receives discount information as a response thereto from the server apparatus 2. The discount information includes price information of a discounted product (a unit price and a discount amount), deadline information (expiration date), and position information (display position). The transmission/reception means 4001 functions as an acquisition means for acquiring information regarding a discounted product. Although the discount information received by the transmission/reception means 4001 is discount information relating to a favorite product of the customer C in this embodiment, the discount information may be discount information relating to all discounted products set by a store.

Further, the transmission/reception means 4001 transmits, to the server apparatus 2, a registration request including an individual item code input to the input means 4002. The transmission/reception means 4001 then receives, when the server apparatus 2 completes product registration in accordance with the registration request, registration notification from the server apparatus 2.

An individual item code that is specific information for specifying a product and a price of the product is input to the input means 4002 from the RFID reader 44. Further, various types of information are input to the input means 4002 from the operation device 43 and the scanner 45.

For example, a membership code read from a member card of the customer C by the scanner 45 is input to the input means 4002 from the scanner 45. Further, information for instructing start of product registration, information for instructing accounting when product registration of all products to be purchased has been completed, and the like are input to the input means 4002 from the operation device 43.

The display control means 4003 displays various types of information on the display device 42. For example, the display control means 4003 displays, on the display device 42, information regarding a product registered on the basis of the individual item code input to the input means 4002. Specifically, the display control means 4003 displays, on the display device 42, product information included in the registration notification received from the server apparatus 2 by the transmission/reception means 4001 (product information registered by the server apparatus 2).

Further, the display control means 4003 displays, on the display device 42, discount information received from the server apparatus 2 by the transmission/reception means 4001. For example, the display control means 4003 displays, on the display device 42, price information of a discounted product, deadline information, position information, and the like, as discount information.

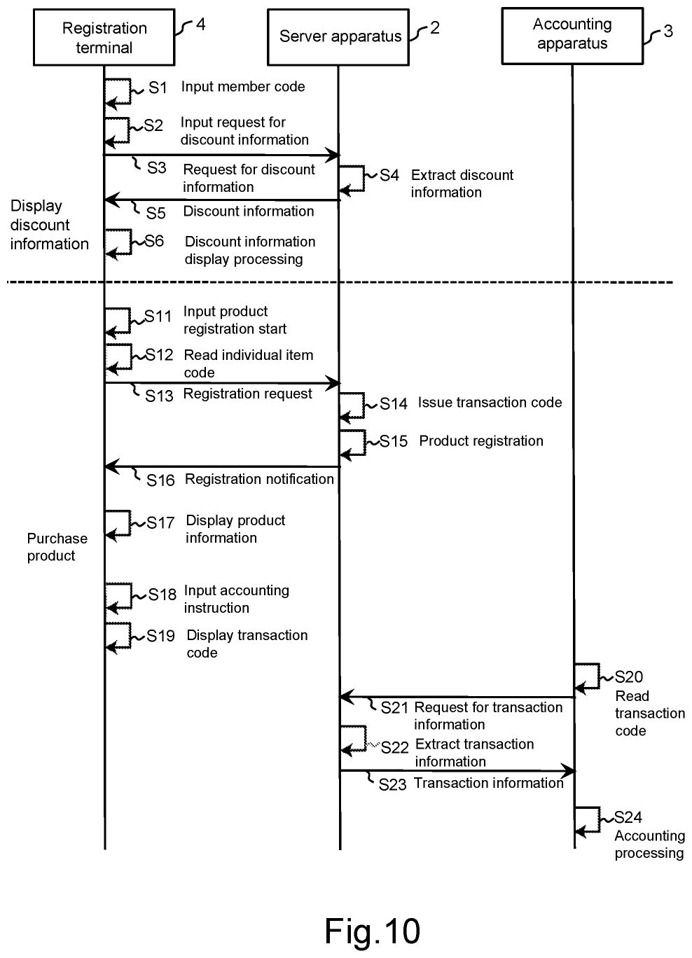

Next, an operation of the product information notification system 1 based on the above configuration will be described. FIG. 10 is a sequence chart showing an operation of the product information notification system 1.

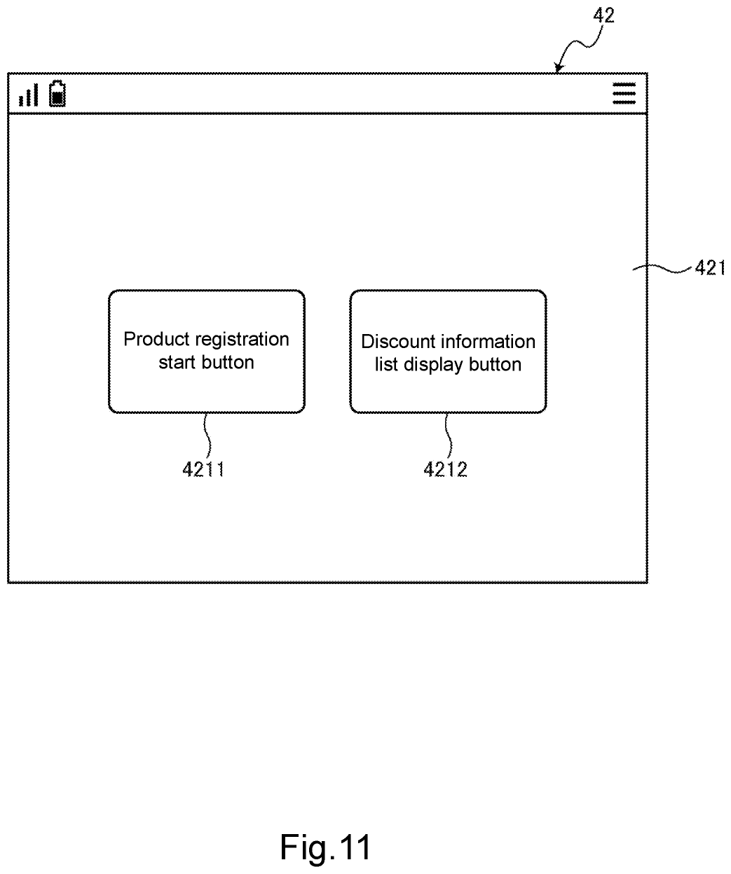

An operation when displaying discount information will be described first. In Step S1, when the customer C starts shopping and causes the scanner 45 to read a membership code, the registration terminal 4 inputs the membership code from the scanner 45. At this time, the registration terminal 4 displays, on the display device 42, a start screen 421 shown in FIG. 11.

A product registration start button 4211 and a discount information list display button 4212 are displayed on the start screen 421. The product registration start button 4211 is an operator for instructing to start product The discount information list display button registration. 4212 is an operator for instructing to display the list of discount information.

In Step S2, when the customer C operates the discount information list display button 4212, the registration terminal 4 inputs a request for discount information. In Step S3, the registration terminal 4 transmits a request for discount information to the server apparatus 2.

In Step S4, the server apparatus 2 extracts discount information relating to a favorite product of the member specified by the membership code included in the request for discount information. In Step S5, the server apparatus 2 transmits the extracted discount information to the registration terminal 4.

In Step S6, the registration terminal 4 executes discount information display processing on the basis of the received discount information. In this way, the registration terminal 4 displays discount information on the display device 42. Details of the discount information display processing executed by the registration terminal 4 will be described below.

Note that the above-mentioned discount information list display button 4212 is desirably provided in not only a start screen but also various screens displayed during shopping. As a result, the customer C can view the discount information at arbitrary timing during shopping.

Subsequently, an operation when the customer C purchases a product will be described. In Step S11, when the customer C operates the product registration start button 4211 on the start screen shown in FIG. 11, the registration terminal 4 inputs an instruction of starting product registration. When the customer C causes a product to be purchased to be located within the reading range of the RFID reader 44, the registration terminal 4 reads the individual item code of the product by the RFID reader 44 in Step S12. In Step S13, the registration terminal 4 transmits, to the server apparatus 2, a registration request including the read individual item code. Note that in the following description, the operation that the customer C causes the registration terminal 4 to read an individual item code or a product code in order to cause the server apparatus 2 to perform product registration will be described as “the customer C scans a product” in some cases.

In Step S14, the server apparatus 2 issues a transaction code. The server apparatus 2 issues a transaction code when a first registration request in one transaction was made from the registration terminal 4. Subsequently, in Step S15, the server apparatus 2 executes product registration. The server apparatus 2 executes product registration by storing information regarding a product corresponding to the individual item code included in the registration request in association with a transaction code. In Step S16, the server apparatus 2 transmits, to the registration terminal 4, registration notification indicating that product registration was made.

In Step S17, the registration terminal 4 displays, on the display device 42, the product information included in the registration notification. As a result, the customer C can check that product registration was performed on the product to be purchased. After that, the processing of Steps S12 to Step S17 is repeated every time the customer C scans a product. Note that the processing of issuing a transaction code in Step S14 is not executed for the second and subsequent registration requests in one transaction.

In Step S18, when product registration of all products to be purchased is completed, the registration terminal 4 inputs an accounting instruction. The registration terminal 4 displays, on the display device 42, information indicating a transaction code included in the registration notification received from the server apparatus 2. For example, the registration terminal 4 displays, on the display device 42, a code symbol such as a barcode indicating a transaction code.

When making payment for the purchases, the customer C moves to the accounting apparatus 3 and scans the code symbol displayed on the registration terminal 4 by the scanner of the accounting apparatus 3. In Step S20, the accounting apparatus 3 reads the transaction code from the code symbol by the scanner. In Step S21, the accounting apparatus 3 transmits, to the server apparatus 2, a request for transaction information including the read transaction code.

In Step S22, the server apparatus 2 extracts transaction information relating to the transaction code included in the request for transaction information. The server apparatus 2 transmits the extracted transaction information to the accounting apparatus 3.

In Step S24, the accounting apparatus 3 executes account processing on the basis of the received transaction information. With the above operation, the customer C can purchase a product.

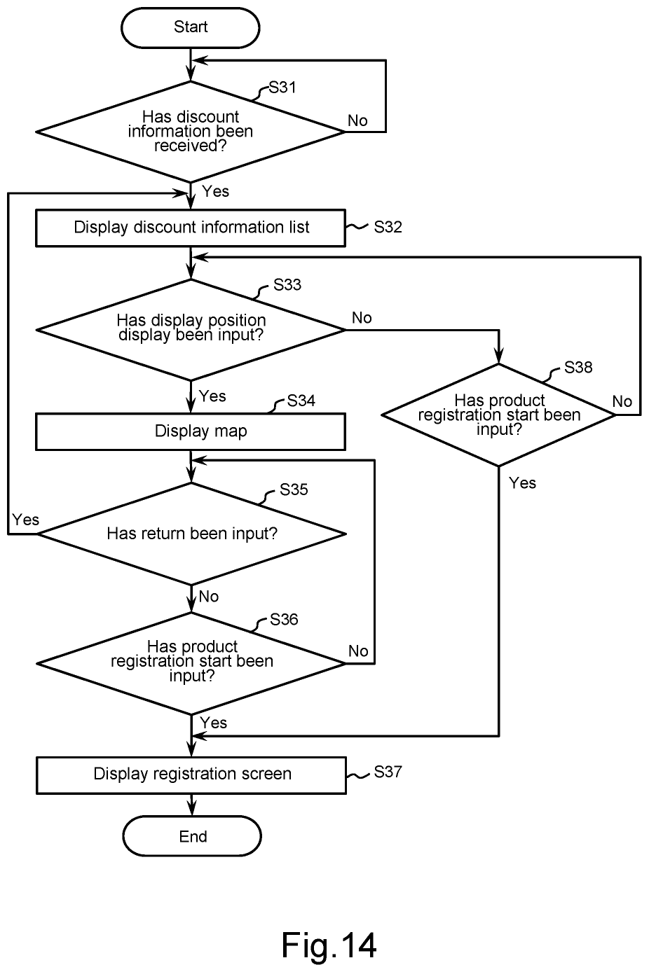

Next, discount information display processing executed by the registration terminal 4 will be described. FIG. 14 is a flowchart showing discount information display processing executed by the controller 40 of the registration terminal 4.

In Step S31, the controller 40 determines whether or not the transmission/reception means 4001 has received discount information from the server apparatus 2. When the transmission/reception means 4001 has not received discount information from the server apparatus 2 (No in Step S31), the processing of the controller 40 returns to Step S31 and stands by.

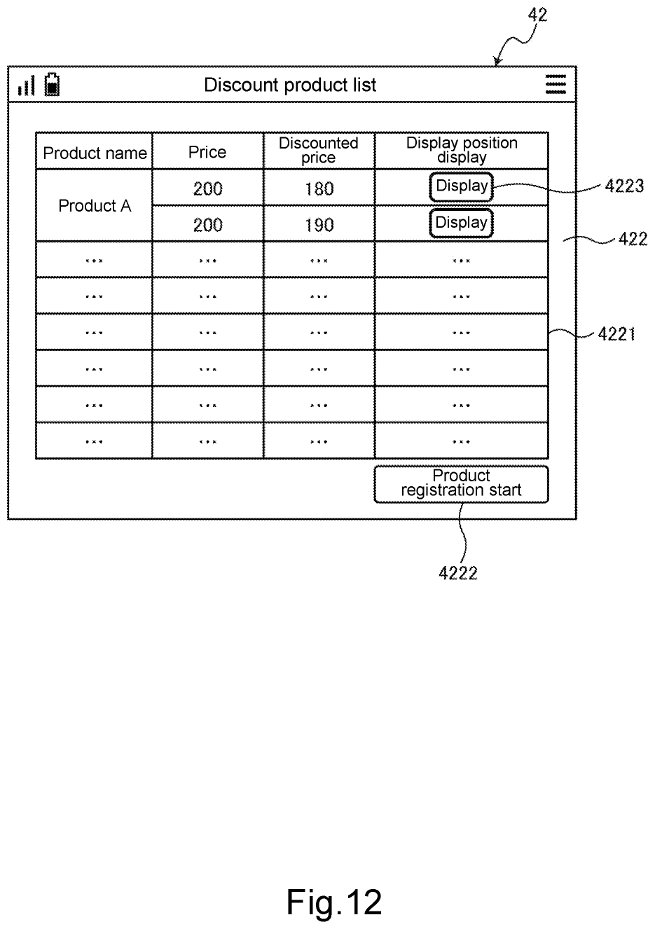

When the transmission/reception means 4001 has received discount information from the server apparatus 2 (Yes in Step S31), the processing of the controller 40 proceeds to Step S32. In Step S32, the display control means 4003 of the controller 40 displays a discount information list screen on the display device 42. FIG. 12 is a diagram showing a discount information list screen 422.

A discount information part 4221 and a product registration start button 4222 are displayed on the discount information list screen 422. The discount information part 4221 displays discount information received from the server apparatus 2 by the transmission/reception means 4001. Specifically, the discount information part 4221 displays information relating to a price, a discounted price, a display position display in association with a product name. Information for each individual item is displayed in each column of the price, the discounted price, and the display position display.

The name of a discounted product is displayed in the column of the product name. The unit price of a product is displayed in the column of the price. The discounted price obtained by subtracting the discount amount from the unit price, i.e., the selling price, is displayed in the column of the discounted price. A display button 4223 is displayed in the column of the display position display. When the display button 4223 is operated, a map screen indicating where the corresponding individual item is displayed is displayed. The map screen will be described.

The product registration start button 4222 is an operator for instructing to start product registration. The customer C can start product registration by operating the product registration start button 4222 on the discount information list screen 422 while checking discount information.

With reference to FIG. 14 again, description of discount information display processing will be continued. In Step S33, the controller 40 determines whether or not an instruction for displaying a display position has been input. In other words, the controller 40 determines whether or not any of the display buttons 4223 has been operated while the discount information list screen 422 is displayed on the display device 42.

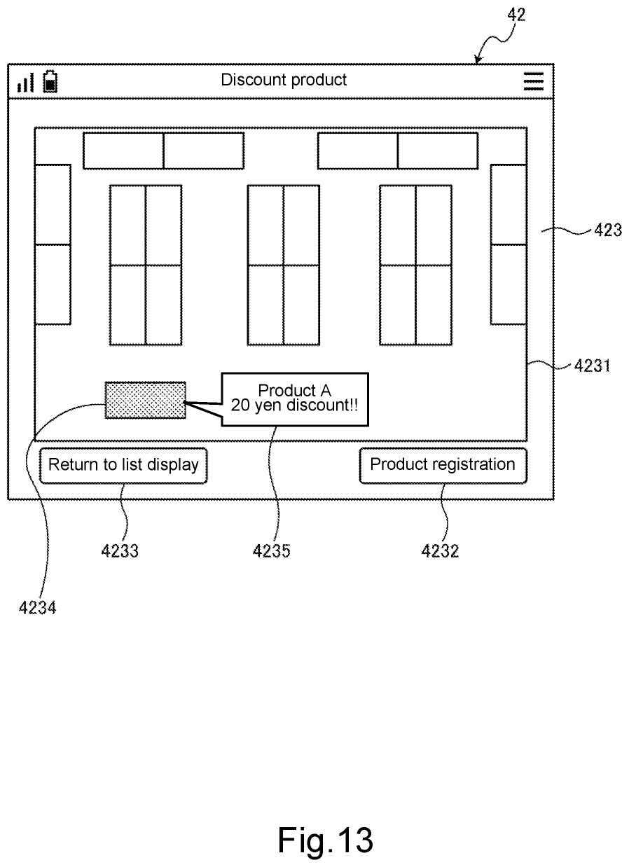

When an instruction for displaying a display position (Yes in Step S33), the processing of the controller 40 proceeds to Step S34. In Step S34, the display control means 4003 of the controller 40 displays a map screen on the display device 42. The map screen is a screen that displays a display position of the individual item designated on the discount information list screen 422. FIG. 13 is a diagram showing a map screen 423.

A map information part 4231, a product registration start button 4232, and a return button 4233 are displayed on the map screen 423. The map information part 4231 displays a map of a sales floor and displays, in a form different from those of other display shelves, a display shelf 4234 on which the designated individual item is displayed. For example, the map information part 4231 displays, in a color different from those of the other display shelves, the display shelf 4234 on which the designated individual item is displayed. Note that the different display form is not limited to differentiating the color, and may be realized by another method, e.g., differentiating the thickness of the outer frame line of the display shelf 4234. Further, the map information part 4231 displays an advertisement information part 4235 in association with the display shelf 4234. As a result, the map information part 4231 is capable of promoting a discounted product to the customer C.

The product registration start button 4232 is an operator for instructing to start product registration. The return button 4233 is an operator for returning the screen display of the display device 42 to the discount information list screen 422. The customer C can appropriately operate the product registration start button 4232 and the return button 4233.

With reference to FIG. 14 again, description of discount information display processing will be continued. In Step S35, the controller 40 determines whether or not an instruction for returning a screen has been input. In other words, the controller 40 determines whether or not the return button 4233 has been operated while the map screen 423 is displayed on the display device 42.

When an instruction for returning a screen has been input (Yes in Step S35), the processing of the controller 40 returns to Step S32. When an instruction for returning a screen has not been input (No in Step S35), the processing of the controller 40 proceeds to Step S36. In Step S36, the controller 40 determines whether or not an instruction for starting product registration has been input. In other words, the controller 40 determines whether or not the product registration start button 4232 has been operated while the map screen 423 is displayed on the display device 42.

When an instruction for starting product registration has been input (Yes in Step S36), the processing of the controller 40 proceeds to Step S37. In Step S37, the display control means 4003 of the controller 40 displays a registration screen (not shown) on the display device 42. The registration screen is a screen for the customer C to perform an operation relating to product registration. The controller 40 then ends the discount information display processing. When an instruction for starting product registration has not been input (No in Step S36), the processing of the controller 40 returns to Step S35.

Note that when an instruction for displaying a display position has not been input in the processing of Step S33 (No in Step S33), the processing of the controller 40 proceeds to Step S38. In Step S38, the controller 40 determines whether or not an instruction for starting product registration has been input. In other words, the controller 40 determines whether or not the product registration start button 4222 has been operated while the discount information list screen 422 is displayed on the display device 42.

When an instruction for starting product registration has been input (Yes in Step S38), the processing of the controller 40 proceeds to Step S37. When an instruction for starting product registration has not been input (No in Step S38), the processing of the controller 40 returns to Step S33.

According to the above first embodiment, when a request for discount information is input, the registration terminal 4 acquires discount information from the server apparatus 2 and displays the acquired discount information. As a result, the customer C can view discount information by the registration terminal 4 at desired timing. For this reason, the customer C can easily recognize discount information.

### Second Embodiment

Next, a second embodiment will be described. The second embodiment is different from the first embodiment in that in the case where the customer C scans a product by the registration terminal 4 and there is a product that is the same as the scanned product and has a different price (hereinafter, referred to also as “the same product at a different price”), information regarding the same product at a different price can be displayed. For example, the same product at a different price is a product sold at a discounted price with respect to a product sold at a normal price in the same products. Further, the same product at a different price is, for example, a product sold at 20 yen discount with respect to a product sold at 10 yen discount in the same products. Hereinafter, description of the same configurations and functions as those in the first embodiment will be omitted in some cases. This is to avoid the following description from being unnecessary redundant and to facilitate understanding by those skilled in the art.

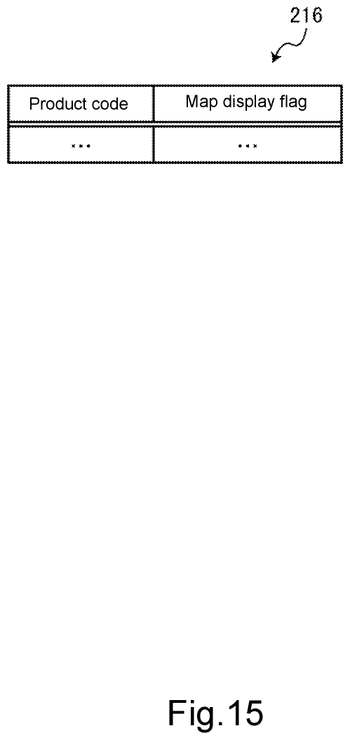

The storage device 21 of the server apparatus 2 has a map display setting table 216 shown in FIG. 15. The map display setting table 216 is a data table for setting, for each product, whether to a display position of the same product at a different price. The map display setting table 216 stores a product code and a map display flag in association with each other.

The product code is information for specifying a product. The map display flag is a flag for setting whether to display, as product information of the same product at a different price, a map screen indicating a display position when the product of the corresponding product code is scanned. “1” is registered in the map display flag in the case where a map screen is displayed as product information of the same product at a different price, and “0” is registered in the map display flag in the case where a map screen is not displayed. The map display flag can be arbitrarily set by a store.

For example, in a store that displays a product sold at a normal price and a product sold at a discounted price in the same products on the same display shelf, it is desirable to register “0” in the map display flag. In general, the customer C performs, near a display shelf on which a product is displayed, product registration of the product. For this reason, it is considerable that in the case where the scanned product and the same product at a different price are displayed on the same display shelf, the customer C is likely to misunderstand that the same product at a different price is displayed on another display shelf when a map screen is displayed.

Meanwhile, in a store that displays a product sold at a normal price and a product sold at a discounted price in the same products on display shelves away from each other, it is desirable to register “1” in the map display flag. For example, in a store in which a discounted product corner where discounted products are collected is set up, it is desirable to register “1” in the map display flag. In the case where the scanned product and the same product at a different price are displayed on display shelves away from each other, it is considerable that by displaying a map screen, the customer C can easily recognize the position of the same product at a different price.

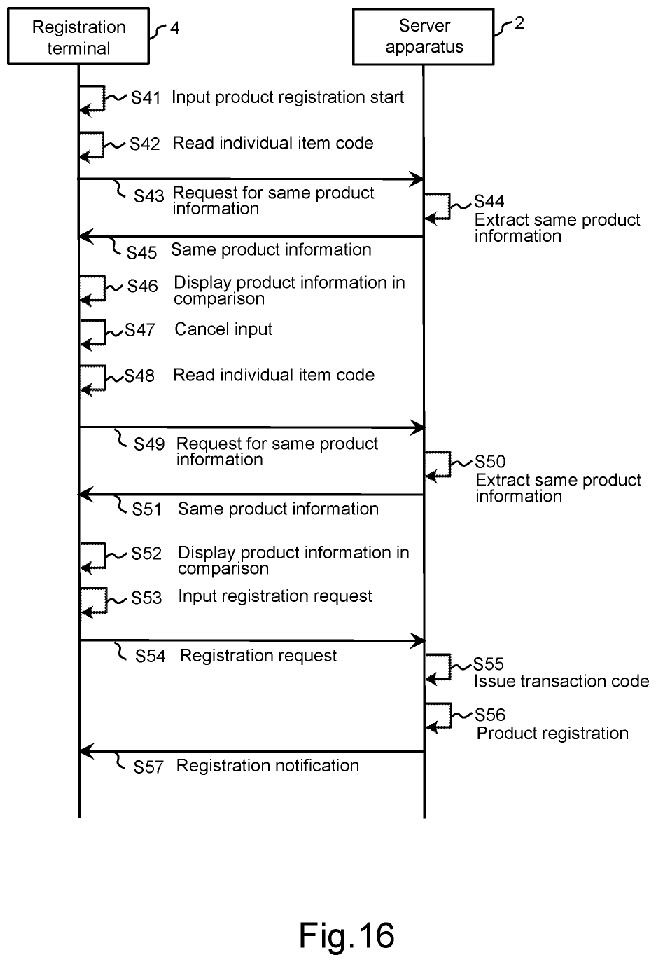

Next, an operation of the product information notification system 1 relating to product registration will be described. FIG. 16 is a sequence chart showing an operation of the product information notification system 1. This sequence chart shows a flow of an operation in the case where product registration of the same product at a different price was performed without performing product registration on the product scanned by the customer C because there is the same product at a different price for the product scanned by the customer C. Further, this sequence chart shows a flow of an operation in the case where a map screen is not displayed.

In Step S41, in order to start product registration, the registration terminal 4 inputs an instruction for starting product registration. In Step S42, when the customer C causes a product to be purchased to be located in the reading range of the RFID reader 44, the registration terminal 4 reads the individual item code of the product by the RFID reader 44. In Step S43, the registration terminal 4 transmits, to the server apparatus 2, a request for the same product information including the read individual item code. The request for the same product information is a request for product information relating to the individual item code included in the request for the same product information and product information of the same product at a different price with respect to the individual item code.

In Step S44, the server apparatus 2 extracts the product information relating to the individual item code included in the request for the same product information and the product information of the same product at a different price with respect to the individual item code. The server apparatus 2 refers to the product master 212 to extract the product information relating to the individual item code included in the request for the same product information. Further, the server apparatus 2 refers to the product master 212 and the inventory management table 213 to extract product information of the same product at a different price on which product registration has not been performed. In Step S45, the server apparatus 2 transmits, to the registration terminal 4, the extracted product information, i.e., product information of the product scanned by the customer C and product information of the same product at a different price with respect to the product (hereinafter, collectively referred to also as “the same product information”). In the case where there is no same product at a different price, the server apparatus 2 transmits information indicating that there is no same product at a different price to the registration terminal 4 as the same product information.

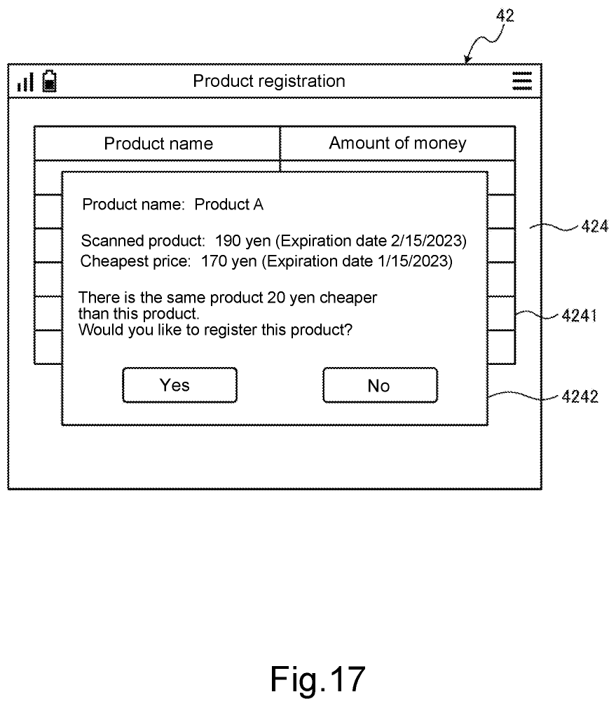

In Step S46, the registration terminal 4 displays the received same product information on the display device 42 in a comparable manner. That is, the same product information is displayed on a registration screen 424 shown in FIG. 17. A registration information part 4241 and a same product information part 4242 are displayed on the registration screen 424.

The registration information part 4241 displays information regarding a product on which product registration has been performed. The same product information part 4242 pops up on the registration information part 4241 in the case where there is the same product at a different price for the product scanned by the customer C. The same product information part 4242 displays product information of the product scanned by the customer C and product information of the same product at a different price with respect to the product in a comparable manner. Specifically, the same product information part 4242 displays the product name, the selling price, and the expiration date of the product scanned by the customer C. Further, the same product information part 4242 displays the selling price and the expiration date of the same product at a different price with respect to the product scanned by the customer C so as to correspond to the selling price and the expiration date of the product scanned by the customer C.

The registration terminal 4 displays information of the product at the cheapest price, of the same products at different prices, so as to correspond to product information of the product scanned by the customer C in this embodiment, as shown in FIG. 17. However, in the case where there is a plurality of same products at different prices, all of them may be displayed. Further, in the case where the scanned product is the cheapest product, it does not necessarily need to display information of the same product at a different price. In this case, the registration terminal 4 may transmit a registration request relating to the scanned product to the server apparatus 2 without displaying information of the same product at a different price.

Further, the same product information part 4242 displays a message prompting to input whether to perform product registration on the scanned product, a Yes button, and a No button. In the case where the customer C checks information of the same product at a different price and then performs product registration on the scanned product, he/she operates the Yes button. In this case, the registration terminal 4 transmits a registration request relating to the scanned product to the server apparatus 2.

In the case where the customer C checks information of the same product at a different price and then decides not to perform product registration on the scanned product, e.g., the customer C desires to purchase the displayed cheapest product, he/she operates the No button. In this case, the registration terminal 4 does not transmit a registration request relating to the scanned product to the server apparatus 2.

With reference to FIG. 16 again, description of an operation of the product information notification system 1 will be continued. When the customer C operates the No button in the same product information part 4242 shown in FIG. 17, the registration terminal 4 inputs an instruction for cancelling the read individual item code in Step S47.

When the customer C scans another product using the scanner 45, the registration terminal 4 reads an individual item code via the scanner 45 in Step S48. The same processing as that of Step S43 to Step S46 is then performed. Specifically, in Step S49, the registration terminal 4 transmits a request for the same product information to the server apparatus 2. In Step S50, the server apparatus 2 extracts the same product information. In Step S51, the server apparatus 2 transmits the extracted same product information to the registration terminal 4. In Step S52, the registration terminal 4 displays the same product information in a comparable manner.

Note that in the case where the individual item code read by the registration terminal 4 corresponds to the same product code as the previously read individual item code, the registration terminal 4 does not necessarily need to display product information in a comparable manner. This is because it is considerable that the customer C has checked the same product at a different price for the product scanned this time at the time of previous scanning and thus, there is a possibility that displaying information of the same product at a different price again actually reduces the operability. In this case, the registration terminal 4 may transmit a registration request relating to the scanned product to the server apparatus 2 without displaying information of the same product at a different price.

When the Yes button is operated on the registration screen 424, the registration terminal 4 inputs a registration request in Step S53. In Step S54, the registration terminal 4 transmits a registration request to the server apparatus 2.

In Step S55, the server apparatus 2 issues a transaction code. In Step S56, the server apparatus 2 executes product registration. In Step S57, the server apparatus 2 then transmits registration notification to the registration terminal 4. After that, the same processing as that in the first embodiment is performed.

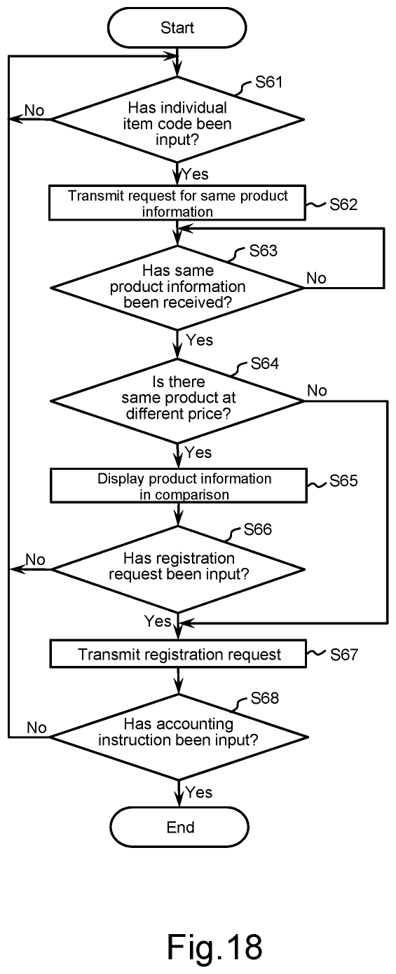

Next, registration processing executed by the registration terminal 4 will be described. FIG. 18 is a flowchart showing a flow of registration processing executed by the controller 40 of the registration terminal 4.

In Step S61, the input means 4002 of the controller 40 determines whether or not an individual item code has been input. When an individual item code has not been input (No in Step S61), the processing of the controller 40 returns to Step S61 and stands by.

When an individual item code has been input to the input means 4002 (Yes in Step S61), the processing of the controller 40 proceeds to Step S62. In Step S62, the transmission/reception means 4001 of the controller 40 transmits, to the server apparatus 2, product information relating to the input individual item code and a request for the same product information, which is a request for information of the same product at a different price with respect to the individual item code. In Step S63, the controller 40 determines whether or not the transmission/reception means 4001 has received the same product information that is a response to the request for the same product information. When the transmission/reception means 4001 has not received the same product information (No in Step S63), the processing of the controller 40 returns to Step S63 and stands by.

When the transmission/reception means 4001 has received the same product information (Yes in Step S63), the processing of the controller 40 proceeds to Step S64. In Step S64, the controller 40 determines whether or not the received same product information includes product information of the same product at a different price, i.e., whether or not the received same product information indicates the presence or absence of the same product at a different price. When there is the same product at a different price (Yes in Step S64), the processing of the controller 40 proceeds to Step S65. In Step S65, the display control means 4003 of the controller 40 displays product information on the display device 42 in a comparable manner. The display of the product information in a comparable manner is made by the registration screen 424 shown in FIG. 17.

Subsequently, in Step S66, the controller 40 determines whether or not a registration request has been input to the input means 4002. In other words, the controller 40 determines whether or not the Yes button of the same product information part 4242 of the registration screen 424 (FIG. 17) has been operated.

When a registration request has been input to the input means 4002 (Yes in Step S66), the processing of the controller 40 proceeds to Step S67. In Step S67, the transmission/reception means 4001 of the controller 40 transmits a registration request to the server apparatus 2. In Step S68, the controller 40 determines whether or not an accounting instruction has been input to the input means 4002. In the case where an accounting instruction has been input (Yes in Step S68), the controller 40 ends the registration processing.

When there is no same product at a different price in Step S64 (No in Step S64), the processing of the controller 40 proceeds to Step S67. That is, in the case where there is no same product at a different price with respect to the product scanned by the customer C, the registration terminal 4 transmits a registration request for the scanned product to the server apparatus 2 without displaying anything. Further, when an accounting instruction has not been input to the input means 4002 in Step S68 (No in Step S68), the processing of the controller 40 returns to Step S61.

According to the above second embodiment, the registration terminal 4 displays discount information, similarly to the first embodiment, the customer C can easily recognize the discount information. In addition, in the case where the customer C scans a product and there is the same product at a different price with respect to the product, the registration terminal 4 according to the second embodiment displays the product information thereof. As a result, the customer C can view discount information of the product to be purchased by himself/herself when scanning the product. For this reason, the registration terminal 4 is capable of improving the convenience of the customer C.

Further, according to the second embodiment, the registration terminal 4 displays not only product information of a discounted product but also product information of the same product at a different price with respect to the product scanned by the customer C. For example, the registration terminal 4 is also capable of displaying product information of a product at a normal price, which is the same product as the scanned product, when the customer C scans the cheapest discounted product. As a result, the customer C can view the expiration date of the same product at a different price when scanning a discounted product near the expiration date. For this reason, the registration terminal 4 is capable of expanding the selection of products of the customer C.

### Modification

Next, a modification of the first embodiment and the second embodiment will be described. In the first embodiment and the second embodiment, a discount amount set for each individual item is managed using the product master 212. On the other hand, in the modification, a discount amount set for each discount code is managed using a discount information management table 218.

In the modification, since discount information is not managed on the basis of an individual item code, it does not necessarily need to use an RF tag. In the modification, assumption is made that a barcode indicating a product code is attached to a product at a normal price and a barcode indicating a product code and discount code is attached to a discounted product. In the modification, the product code and the discount code form specific information for specifying a product and the prices of the product.

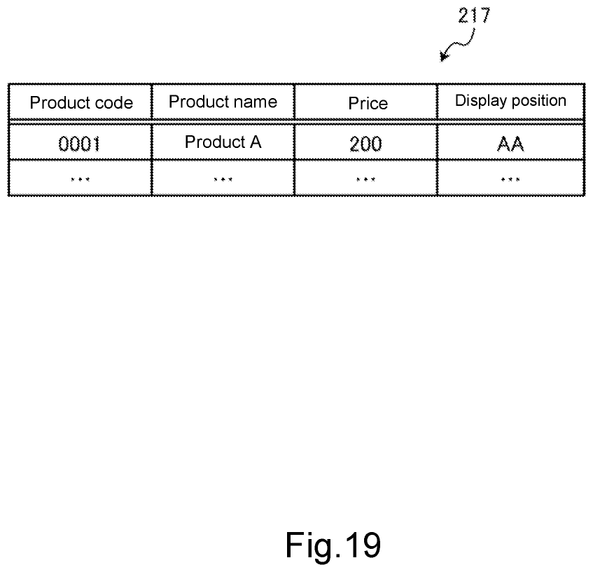

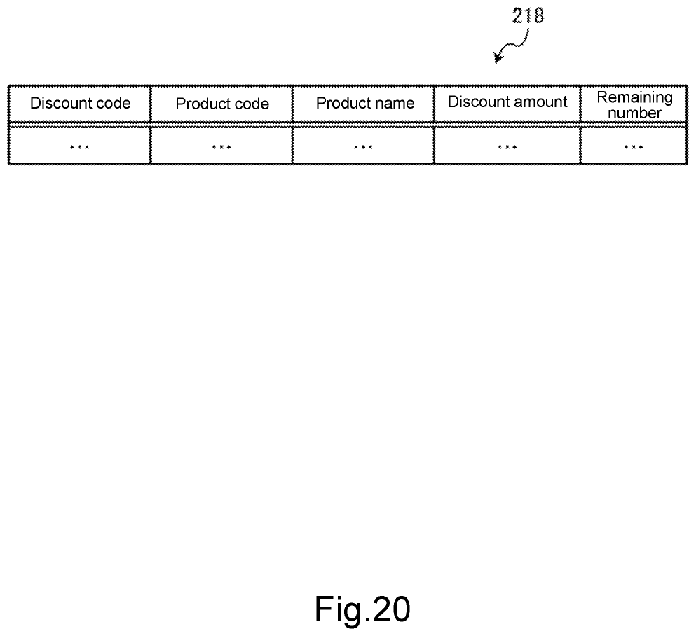

The storage device 21 of the server apparatus 2 stores a product master 217 shown in FIG. 19 and the discount information management table 218 shown in FIG. 20.

The product master 217 stores a product name, a price, and a display position in association with a product code. Since the product code, the product name, the price, and the display position have been described in the first embodiment, overlapping description will be omitted.

The discount information management table 218 is a data table for managing information relating to a discounted product at the current point. The discount information management table 218 is updated on the basis of information from a label printer (not shown) that issues a discount label to be attached to a product and information from the registration terminal 4. The discount information management table 218 stores a product code, a product name, a discount amount, and a remaining number in association with a discount code.

The discount code is information for specifying a discount amount. Since the product code, the product name, and the discount amount have been described in the first embodiment, overlapping description will be omitted. The remaining number is information indicating the stock quantity of the discounted product specified by the corresponding discount code and product code.

In the above configuration, in the case of the modification of the first embodiment, when a request for discount information is input to the registration terminal 4, the registration terminal 4 transmits the request for discount information to the server apparatus 2. The server apparatus 2 extracts, a product code whose corresponding remaining number is not “0”, of the product codes registered in the discount information management table 218.

The server apparatus 2 reads, from the discount information management table 218 (FIG. 20), a discount amount corresponding to the extracted product code. Further, the server apparatus 2 reads, from the product master 217 (FIG. 19), a product name, a price, and a display position corresponding to the extracted product code. The server apparatus 2 generates discount information in association with the read product name, price, discount amount, and display position, and transmits the generated discount information to the registration terminal 4. The registration terminal 4 displays the received discount information. As a result, the registration terminal 4 is capable of displaying discount information, similarly to the first embodiment.

In the case of the modification of the second embodiment, when the customer C scans a product, the registration terminal 4 reads a product code and transmits a request for the same product information including the product code to the server apparatus 2.

The server apparatus 2 reads, from the product master 217 (FIG. 19), a product name, a price, and a display position corresponding to the product code included in the request for the same product information, and generates product information of the scanned product. Further, the server apparatus 2 reads, from the discount information management table 218 (FIG. 20), a discount amount corresponding to the product code included in the request for the same product information. The server apparatus 2 generates product information of the same product at a different price in association with the product name, price, and display position read from the product master 217 (FIG. 19) and the discount amount read from the discount information management table 218.

The server apparatus 2 transmits, to the registration terminal 4, the same product information including product information of the scanned product and product information of the same product at a different price. The registration terminal 4 displays the product information of the scanned product and the product information of the same product at a different price in a comparable manner. In this way, similarly to the second embodiment, the registration terminal 4 is capable of displaying product information of the scanned product and product information of the same product at a different price in a comparable manner.

According to the modification, it is possible to achieve the same effects as those in the first embodiment and the second embodiment without attaching an RF tag storing an individual item code to a product.

As described above, the registration terminal 4 according to the above embodiments is an information processing apparatus that moves around a sales floor with the customer C and executes processing relating to product registration. The controller 40 of the registration terminal 4 executes, on the basis of the control program stored in the storage device 41, functions as the transmission/reception means 4001, the input means 4002, and the display control means 4003. That is, the controller 40 functions as the input means 4002 to input specific information for specifying a product and a price of the product. The controller 40 functions as the display control means 4003 to display, on the display device 42, information regarding a product registered on the basis of the input specific information. The controller 40 functions as the transmission/reception means 4001 to acquire information regarding a discounted product. The controller 40 functions as the display control means 4003 to display the acquired information regarding a product on the display device 42.

As a result, the customer C can view discount information by the registration terminal 4 that performs an operation relating to product registration. For this reason, the customer C can easily recognize discount information.

Further, in the registration terminal 4 according to the above embodiments, the controller 40 functions as the transmission/reception means 4001 to acquire information regarding a discounted product relating to a product set for each customer C.

As a result, the registration terminal 4 is capable of displaying discount information useful for the customer C. Therefore, the registration terminal 4 is capable of improving the convenience of the customer C.

Further, in the registration terminal 4 according to the above embodiments, the controller 40 functions as the transmission/reception means 4001 to acquire information regarding a product at a price, which is the same product as the product specified by the input specific information, the price being different from that of the specified product.

As a result, the registration terminal 4 is capable of displaying, when the customer C scans a product, product information of a product at a price, which is the same product as the scanned product, the price being different from that of the scanned product. For this reason, the customer C can view discount information of a product to be purchased by himself/herself when scanning the product. Therefore, the registration terminal 4 is capable of improving the convenience of the customer C.

In addition, in the registration terminal 4 according to the above embodiments, the controller 40 functions as the transmission/reception means 4001 to acquire, as information regarding a product, price information indicating a price and deadline information indicating a deadline. As a result, the registration terminal 4 is capable of displaying price information of a discounted product and deadline information. For this reason, the customer C can select a product to be purchased in consideration of price information and deadline information. In this respect, the registration terminal 4 is capable of improving the convenience of the customer C.

Further, in the registration terminal 4 according to the above embodiments, the controller 40 functions as the transmission/reception means 4001 to acquire, as information regarding a product, position information indicating a display position of a discounted product.

As a result, the registration terminal 4 is capable of displaying position information indicating a display position of a discounted product. For this reason, the customer C can easily recognize a display position of a discounted product. In this respect, the registration terminal 4 is capable of improving the convenience of the customer C.

Note that in the above embodiments, the control program executed by the respective apparatuses of the server apparatus 2, the accounting apparatus 3, and the registration terminal 4 may be recorded in a computer-readable recording medium such as a CD-ROM and provided. Further, the control program executed by the respective apparatuses in the above embodiments may be stored in a computer connected to a network such as the Internet and provided by being downloaded through the network or may be provided through a network such as the Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus that moves around a sales floor with a customer and executes processing relating to product registration, comprising:
an input device that inputs specific information for specifying a product sold in the sales floor and a price of the product;
a communication device that communicates with a server apparatus, the server apparatus managing discount information of a product sold in the sales floor, outputting information regarding a discounted product, and registering a product on a basis of the specific information input by the input device;
a display device that displays information regarding the product registered by the server apparatus; and
a controller configured to
acquire the information regarding a discounted product from the server via the communication device, and
display the acquired information regarding a discounted product on the display device.

2. The information processing apparatus according to claim 1, wherein
the controller is further configured to acquire information regarding a discounted product relating to a product set for each customer.

3. The information processing apparatus according to claim 2, wherein
the controller is further configured to acquire the information regarding a discounted product from the server on a basis of customer specifying information for specifying a customer.

4. The information processing apparatus according to claim 1, wherein
the controller is further configured to acquire, from the server, information regarding a discounted product at a price, which is the same product as the product specified by the specific information input by the input device, the price being different from that of the specified product.

5. The information processing apparatus according to claim 4, wherein
the controller is further configured to acquire price information indicating a price and deadline information indicating a deadline as the information regarding a discounted product.

6. The information processing apparatus according to claim 4, wherein
the controller is further configured to acquire position information indicating a display position of a product in the sales floor as the information regarding a discounted product.

7. The information processing apparatus according to claim 4, wherein
the controller is further configured to acquire price information indicating a price, deadline information indicating a deadline and position information indicating a display position of a product in the sales floor as the information regarding a discounted product.

8. A product information notification system, comprising:
an information processing apparatus that moves around a sales floor with a customer and executes processing relating to product registration; and
a server apparatus capable of communicating with the information processing apparatus, wherein
the server apparatus
manages discount information of a product sold in the sales floor and outputs information regarding a discounted product, and
registers a product on a basis of specific information for specifying a product and a price of the product, and
the information processing apparatus includes
an input device that inputs specific information for specifying a product sold in the sales floor and a price of the product,
a communication device that communicates with the server apparatus,
a display device that displays information regarding the product registered by the server apparatus, and
a controller configured to
acquire the information regarding a discounted product from the server via the communication device, and
display the acquired information regarding a discounted product on the display device.

9. The product information notification system according to claim 8, wherein
the controller is further configured to acquire information regarding a discounted product relating to a product set for each customer.

10. The product information notification system according to claim 9, wherein
the controller is further configured to acquire the information regarding a discounted product from the server on a basis of customer specifying information for specifying a customer.
